(19) United States
(12) Patent Application Publication
(10) Pub. No.: US 2014/0372216 A1
(43) Pub. Date: Dec. 18, 2014

(54) CONTEXTUAL MOBILE APPLICATION ADVERTISEMENTS

(71) Applicant: Microsoft Corporation, Redmond, WA (US)

(72) Inventors: Suman K. Nath, Redmond, WA (US); Xiaozhu Lin, Houston, TX (US); Lenin Ravindranath Sivalingam, Redmond, WA (US); Jitendra Padhye, Redmond, WA (US)

(21) Appl. No.: 13/916,996

(22) Filed: Jun. 13, 2013

(51) Int. Cl. G06Q 30/02

(52) U.S. Cl. CPC G06Q 30/0256
USPC 705/14.54

(57) ABSTRACT

Aspects of the subject disclosure are directed towards retrieving advertisements relevant to application content based upon keywords extracted from the application content. In one aspect, a client-side component scrapes application page content to obtain keywords and feature-based weights for those keywords. The keywords are sent to an advertisement server, which returns an advertisement based upon one or more of the keywords. Also described is the hashing of keywords before sending to the advertisement server to protect client privacy, and the use of a Bloom filter to avoid sending keywords to the advertisement server that do not correspond to (e.g., popular) advertisement keywords.

### BACKGROUND

Mobile device applications have become a primary way in which many users receive content. Indeed, studies have shown that consumers spent more time on mobile applications than on traditional websites.

Notwithstanding, advertisers spend significantly less money on mobile application advertisements than on traditional website advertisements. One likely reason is that unlike most web applications providers, contemporary mobile advertisements tend to be highly irrelevant to the user's interests, and thus not rewarding to advertisers. For example, it is not uncommon to see gambling advertisements being displayed in an application that is directed towards providing religious content. This irrelevance results in low clickthrough rates, whereby advertisers tend to avoid or to devalue the mobile platform.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards receiving advertisements (or other relevant content) based upon application page content. A keyword set comprising one or more keywords is extracted from application page content, and sent to an advertisement server to receive an advertisement. The received advertisement is rendered in conjunction with the application page content.

In one aspect, an auxiliary content server is configured with a memory and processor to execute code, including to receive a keyword set from a client, the keyword set including at least one data item having a local weight computed for the data item at the client. A global weight (e.g., accessed by the auxiliary content server) is combined with the local weight for at least one data item of the keyword set into a final score for that item. Auxiliary content (e.g., an advertisement) based upon the data item and score is retrieved and returned to the client.

In one aspect, application page content is processed, including extracting a plaintext keyword from the page content. A local weight is computed for the keyword based upon local features, and the plaintext keyword is hashed into a hashed keyword. After determining that the hashed keyword is represented in a data structure (e.g., a Bloom filter or any other suitable structure) that maintains compressed data representative of advertising keywords, an advertisement request is sent to an advertisement server; the request includes a keyword set including the hashed keyword and the local weight. An advertisement from the advertisement server is received in response to the request.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing components for retrieving an advertisement relevant to application page content for rendering in conjunction with the page content, according to one example implementation.

FIG. 2 is a block diagram representing a flow of a keyword set from a client to an advertising server, and the use of that keyword set to receive one or more advertisements from an advertisement network, according to one example implementation.

FIG. 3 is a flow diagram representing example steps that may be taken by a client device to provide keywords from application content to an advertisement serer to receive and render an advertisement relevant to the content, according to one example implementation.

FIG. 4 is a flow diagram representing example steps that may be taken by a server to process a keyword set received from a client device to obtain one or more advertisements from an advertisement network based upon the keyword set, according to one example implementation.

FIG. 5 is a block diagram representing an example non-limiting computing system or operating environment, exemplified as a mobile device, in which one or more aspects of various embodiments described herein can be implemented.

### DETAILED DESCRIPTION

Various aspects of the technology described herein are generally directed towards providing advertisements (or other auxiliary content) that are more relevant by taking into account the content of the page on which the advertisement is displayed, e.g., to provide contextual mobile application advertisements. To this end, the content of a mobile application is processed at runtime to extract keywords (and possibly other representative content), with the extracted keywords used to fetch contextually relevant advertisements. Note that unlike web pages, which can be crawled and indexed offline for contextual advertising, content shown on mobile applications is often generated dynamically, or is embedded in the applications themselves, and hence cannot be crawled in advance.

In one aspect, the runtime extraction of content may be performed without excessive overhead. Further, the runtime extraction of content that is used to fetch other content from a server may be performed without violating user privacy.

It should be understood that any of the examples herein are non-limiting. For instance, advertising is a significant type of auxiliary content that may be fetched based upon application-rendered content, however other types of auxiliary content may be fetched in a similar way. Further, many examples used herein refer to using text to determine the representative content extracted from the page, however anything known about other content on the page (e.g., information about a displayed image) may be used in retrieving relevant advertisements/auxiliary content. Still further, it is understood that the technology described herein is directed to one type of “signal” that may be used to retrieve relevant auxiliary content, however this signal may be combined with one or more other types of signals (e.g., location, user history, user preferences, application metadata and so on) to make a final auxiliary content (e.g., advertisement) selection determination. Moreover, while a mobile application is used as an example that has its content processed at runtime, generally because much of such content is dynamic and cannot be crawled in advance, other technologies may benefit from the technology described herein, not necessarily content rendered on a mobile device and/or by a mobile application. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and/or providing content (e.g., advertising) in general.

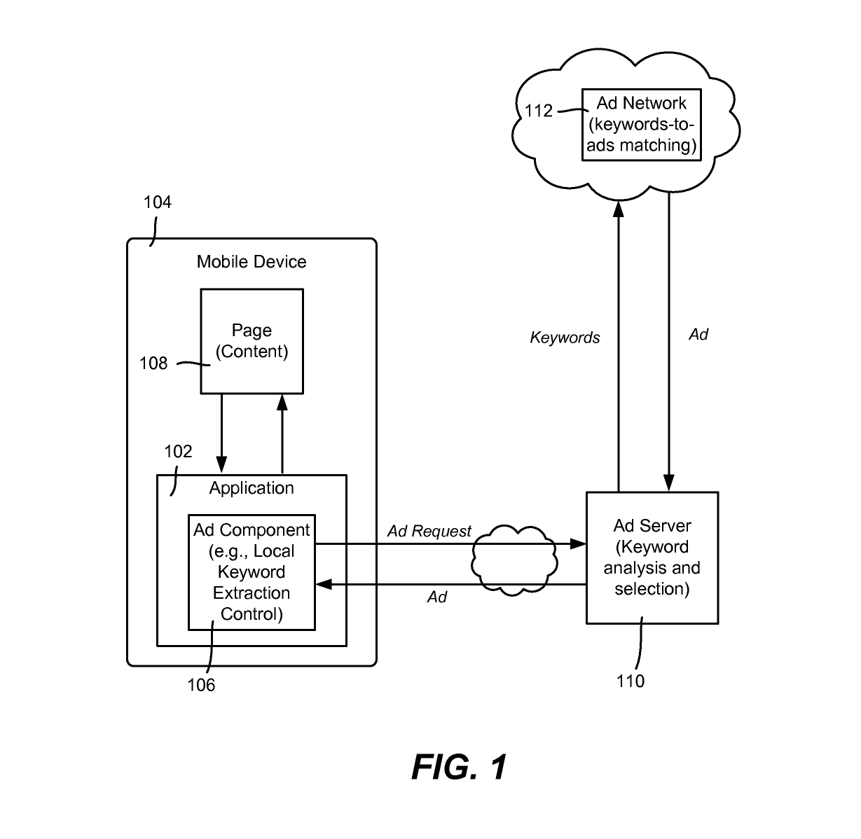

FIG. 1 is a general block diagram showing example concepts of the technology described herein. In general, an application 102 such as running on a mobile device 104 includes a client-side advertisement (ad) component 106. The client-side component 106 may be implemented as an executable control or the like, and in general is used for extracting keyword-related data from application pages as described herein. The component 106 may be a library, e.g., a dynamic link library or DLL that developers can include in an application page, such as programmatically or by dragging and dropping from a control toolbox, or via a tool that can insert the advertisement client into existing applications with binary rewriting techniques.

When an application running the component 106 renders a page 108 of content, the client-side advertisement component 106 “scrapes” the content as described herein to extract keyword related data from the page 108. For example, after an application page 108 is loaded, the client component 106 processes the current page content to generate a list of candidate keywords; (other processing, such as stopword filtering may be performed to eliminate words that are not useful keywords). Typical application pages are organized as a hierarchy of UI controls (e.g., text box, images, list box), and thus scraping may be done by traversing the hierarchy and extracting text that is in such UI controls. Note that the extraction may occur periodically and/or otherwise, such as when rendered content changes. In general, prominent keywords are extracted from the current application page 108, and those keywords used as a basis for requesting an advertisement from an advertisement server 110.

More particularly, the advertisement component 106 is coupled to an advertisement server 110, e.g., via a cloud connection; that is, the advertisement server 110 may run in the cloud as a service or the like. The server 110 also may participate in keyword extraction and selection, as described herein.

As is known with any content, some words are likely to be more relevant to the gist of a page than other words. As described herein, each of the keywords extracted by the client-side advertisement component 106 may be associated with a local weight based upon local (client-side) features related to that keyword. The weight of a keyword determines its score relative to other keywords. Note that while it is feasible to send the page 108 to a server for extraction of the keywords, or send all (or most) of the keywords and their metadata (for weight computation based upon the features) to a server for weight computation, this is highly inefficient. Moreover, as described herein, there are privacy issues with sending a page (the page may contain bank account information, for example). Efficiency and privacy are thus reasons for having the client perform some of the computation (as well as hash-based obfuscation as described herein).

With respect to achieving good utility, to extract prominent keywords from an application page, one implementation of the client-side component 106 is generally based upon a well-known keyword extractor. However, such keyword extractors are directed to webpage-specific features, whereas the extraction described herein is based upon application features; further, the component 106 is configured to address efficiency and privacy concerns.

Given a current page 108, the client-side advertisement component 106 produces a ranked list of keywords having scores between zero and one according to learned feature weights, with the score indicating how useful each keyword is likely to be in selecting a relevant advertisement. As used herein, the term “keyword” with respect to the client-side is used to represent the information extracted from the page 108, whether actual text on the page (including single words or multiple word phrases) or any other contextual information (such as information regarding an image on the page).

The client-side advertisement component 106 includes a trained classifier. Given a feature vector of a word W in document D, the classifier determines the likelihood score of W being an advertising keyword. More formally, the classifier predicts an output variable Y given a set of input features X associated with a word W. Y is one (1) if W is a relevant keyword, and zero (0) otherwise. The classifier returns the estimated probability, P(Y=1| X̅= x̅):

$$P ( Y = 1 \vert \overline{X} = \overline{x} ) = \frac{exp ( \overline{x} \cdot \overline{w} )}{1 + exp ( \overline{x} \cdot \overline{w} )}$$

where the vector of weights is w̅, and wᵢ is the weight of input feature xᵢ.

Unlike traditional keyword extractors, the client-side extraction component 106 described herein excludes features that do not apply to application pages. As one example, traditional keyword extractors assign a higher weight to a word that appears in the HTML header, which does not apply for application pages. However, some local features apply to both application content and web pages, and thus the client-side extraction component 106 may use keyword extractor-type features that are also applicable to application pages:
AnywhereCount: The total number of times the word appears in the page.
NearBeginningCount: The total number of times the word appears in the beginning of the page, where in one implementation, beginning is defined as the top third of the screen.
SentenceBeginningCount: The number of times the word starts a sentence.
PhraseLengthInWord: Number of words in the phrase.
PhraseLengthInChar: Number of characters in the phrase.
MessageLength: The length of the line, in characters, containing the word.
Capitalization: Number of times the word is capitalized in the page, which indicates whether the word is a proper noun or an important word.
Font size: Font size of the word.

Further, application pages have features that are not found in HTML pages. For example, a rich UI element (e.g., TextBox) containing user input is a good indicator of a word's importance. Thus, the presence of a keyword in a UI element may be included in the list of document features that the extraction mechanism considers in its ranking function; the type of UI element may be given a separate weight; for example, a word may have a different weight depending on whether that word appears in a text box or a list box.

The classifier in the component 106 may be trained with a machine learning model based upon a relatively large corpus of labeled page data to determine the relative weights of various features, including the UI elements. Once such weights are learned from training data, they can be readily incorporated into the component 106. Feedback from actual usage may be used to further tune the weights, e.g., the classifier may be updated from time to time.

In one implementation, the request for an advertisement sent to the advertisement server comprises a list of keywords (or hashed representations thereof) along with a local weight for each keyword. The list may be pruned to contain only those keywords that are likely to match an advertisement's keywords, as described below. Further, note that instead of the plaintext keywords being on the list, a hash of each listed keyword may be sent for privacy reasons, as also described herein.

In one implementation, the advertisement server 110 analyzes the keywords and local weights sent by the client and ranks the keywords. As part of the analysis, the advertisement server 110 may add a global weight (e.g., based upon keyword popularity) to the local weight to determine a final ranking score for each keyword. The server operations with respect to extraction/global knowledge inclusion are described below.

The advertisement server 110 sends a request to an advertisement network 112 for one or more advertisements matching the keyword set, e.g., the top ranked keyword or the top N keywords. The advertisement server 110 can use any advertisement network 112 that can return an advertisement for a given keyword set. For example, the advertisement network 112 may be an (e.g., third-party) entity that accepts bids and advertisements from a variety of sources. Note that the advertisement network 112 may use any internal/proprietary process to select one or more advertisements based upon one or more keywords, and such an internal/proprietary selection process is not described herein.

Depending on the protocol between the advertisement sever 110 and the advertisement network 112, the advertisement network 112 may return any number of advertisements that it may have for the keyword or keywords sent by the advertisement server 110. If multiple advertisements are returned from the advertisement network 112, the advertisement server 110 selects one advertisement, e.g., one matching the highest-ranked keyword, and returns that advertisement to the client for displaying.

Turning to additional details regarding the client (e.g., mobile device 104) and advertisement server 110 operations, as described herein, part of the functionality of the overall system is based upon keyword extraction. Given an application's page data, the advertisement component 106 extracts prominent keywords that describe the theme or gist of the application page 108 and that can be matched with available advertisements. Existing keyword extractors are designed for extracting advertisement keywords from webpages. Such extractors offer reasonably good utility, but pose a tradeoff between efficiency and privacy depending on where the extraction is done.

The process of determining which keyword or keywords to send to an advertisement network 112 may be performed entirely on the client, but this has limited success, because good keyword extractors use some global knowledge that is too large to fit in the client's memory. For example, a highly useful component of a keyword extractor for advertisements is a dictionary of bidding keywords and their global popularity among advertisements.

However, a database of keywords on which advertisers bid can be several hundred megabytes in size. For practical reasons, such a database needs to be in the RAM for fast lookup, however most mobile platforms limit the amount of RAM the application can consume to avoid memory pressure. For example, current Windows® phones limit applications to consume only 90 MB of RAM at runtime, and other platforms impose a similar restriction.

Thus, the client cannot practically use such a database of global knowledge to adjust the weights, whereby the server 110 needs to do so if the benefits of global knowledge are to be leveraged. However, in one implementation the client needs to provide the local weights, because running extraction solely at the server is also problematic. Indeed, as described above, extraction only by the server means that the client needs to upload the entire content and layout information of the page, to allow the server to extract the useful features. This not only wastes communication bandwidth (the average page size, including their layout information, is on the order of several kilobytes), but can also compromise user privacy, because sensitive information such as a user's name or bank account number, is likely sent to the server at some point.

To address these concerns, the client and server system described herein in one implementation uses a hybrid keyword extraction architecture, in which the client handles local keyword extraction, and the server handles further keyword processing based upon global knowledge. Note that the scoring function shown in the above Equation is based on dot products of the feature vector x and the weight vector w. Because a dot product is partitionable, the dot product may be computed partially at the client (e.g., for the local features/weights) and partially at the server (e.g., for the global features/weights), and simply summed into a final score. Thus, at the client, the local weights of the keywords may be computed using local information alone. These words, along with their respective local weights, are uploaded to the server 110, which in turn improves the score using the global knowledge weights. The various components of such a system achieve good utility, efficiency, and privacy.

Thus, as described herein, the client side extraction component 106 only deals with local features, because features based upon global knowledge correspond to data that are too large for contemporary client devices. When dealing with advertisements, what is relevant is global knowledge about advertising keywords, e.g., how often advertisers bid on a keyword. A trace collected from an advertisement network over a period of time may be used to collect this knowledge.

Having such a trace, each word may be assigned a global weight based upon frequency, e.g., a weight equal to log(1+frequency), where frequency is how many times the word appears in the bidding keyword trace. This reflects the distribution of the keywords in which advertisers are most interested. Using the above local features and global knowledge, the hybrid client-and-server extraction mechanism determines a good set of advertisement keywords from an application page.

Turning to various aspects related to achieving efficiency with respect to memory overhead, the majority of memory overhead in keyword extraction results from the large amount of global knowledge for keywords. To avoid this overhead at the client side, the extraction functionality is split between the client and the server such that the global knowledge (and associated computation) is maintained at the server. The client does what it can without the global knowledge.

Because uploading all words on the page to the server is wasteful with respect to communication overhead, and can potentially violate privacy, in one implementation, the client does not send any given word to the server if that word has no chance (or little chance) of being selected as one of the extracted keywords at the server. Thus the advertisement client 106 may locally prune unnecessary/likely irrelevant keywords.

To achieve such pruning, the knowledge regarding which keywords advertisers bid on may be used. The client keeps a “list” of such bidding keywords and sends a word to the server 110 only if the word is one of the bidding keywords. However, in practice there are too many bidding keywords (typically hundreds of millions) to fit in the client's memory. Moreover, checking bidding keywords alone is not as advantageous as also considering words that are related to the bidding keywords, further increasing the memory overhead; (related words are described below).

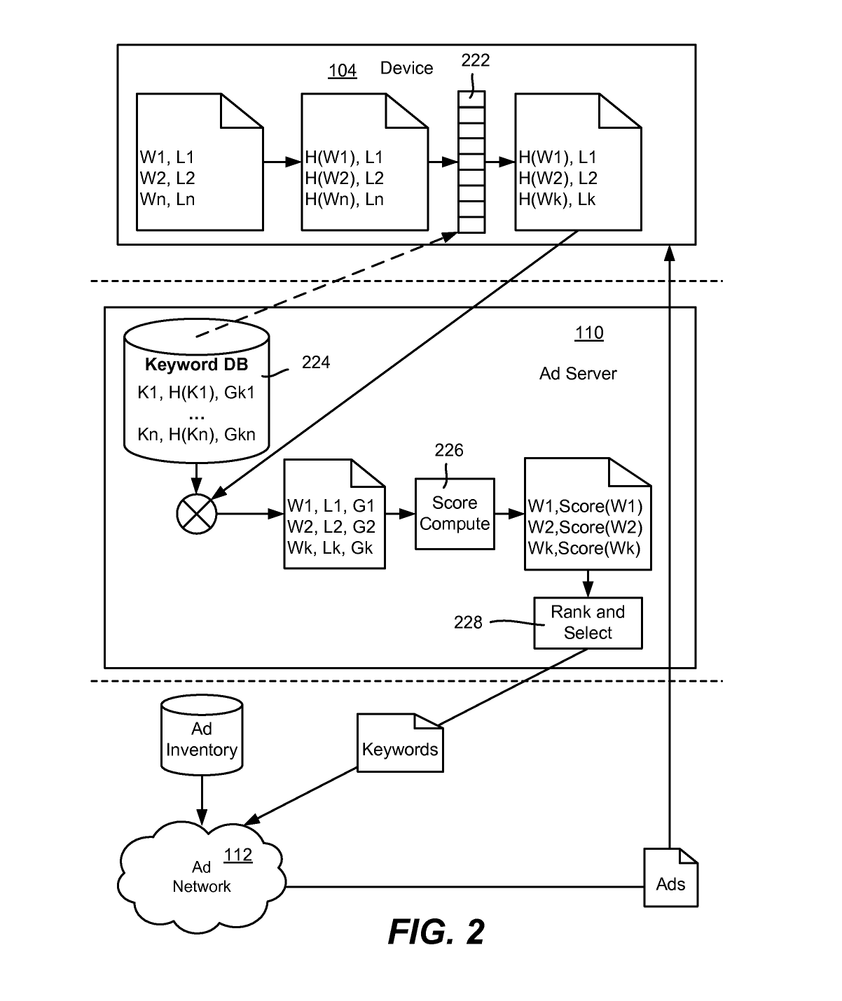

In one implementation, instead of an actual list of bidding keywords, a compressed list of bidding keywords (and if desired related keywords) is provided to the client, e.g., with the list compressed into data structure in the form of a Bloom filter 222 (FIG. 2) in one implementation; (other similar structures may be used, however for purposes of brevity a Boom filter is exemplified herein). As is known, a Bloom filter is a space-efficient probabilistic data structure, which can be used to test whether an element is a member of a set. False positive retrieval results are possible, but false negatives are not.

The Bloom filter 222 or other structure is constructed by the server 110, from its database 224 of bidding keywords and related keywords, and sent to the advertisement client 106 (FIG. 1). The advertisement 106 client uses the Bloom filter 222 to check whether a candidate word is included in the list of bidding keywords or not. The client device 104 sends a word to the advertisement server 110 only if that word passes the Bloom filter check.

However, there can be tens of millions of bidding keywords in an advertisement network, and thus a Bloom filter can be very large if all or most bidding keywords are included. More particularly, the size of a Bloom filter depends on the number of items and the false positive rate of lookups that a system is willing to tolerate. Simple mathematical analysis shows that for n items and a false positive rate of p, the optimal size of a Bloom filter is

$$- \frac{n ln p}{{( ln 2 )}^{2}}$$

bits. The use all bidding keywords results in a Bloom filter that is impractical in size for storing and using in a smartphone.

Therefore, another optimization may be used, namely including only a relatively small number of bidding keywords that cover most of advertisements in the advertisement network. To this end, there are many popular bidding keywords each of which appears in labels of a large number of advertisements. In particular, frequencies of bidding keywords follow a power law distribution, meaning that a small number of bidding keywords appear in most of the advertisements. For example, approximately two percent of the most frequent bidding keywords can fit in a smartphone's memory and yet cover approximately ninety percent of the advertisements. The system may therefore use a smaller fraction of the total number of bidding keywords and yet still achieve a high coverage of advertisements.

To ensure that the remaining (e.g., approximately ten percent) of advertisements actually get served to clients, the advertisement server can prioritize them when application pages do not contain enough keywords. Other techniques are feasible, e.g., random or round-robin insertion from time to time, such as by occasionally sending keywords not represented in the bloom filter to the advertisement network 112, to ensure that advertisements are fairly served.

Note that a Bloom filter is not incrementally updatable, in that even though new items can be added dynamically, items cannot be deleted; (deletion is supported in a counting Bloom filter, but a counting Bloom filter has a larger memory footprint and thus is not used in one implementation). Therefore, as the set of bidding keywords used for local pruning changes significantly, the client needs to re-download an entire new Bloom filter from the server. For practical reasons, this tends to happen rarely, and indeed, actual data supports this proposition. The relatively infrequent update rate, along with the relatively small size of the Bloom filter (when only a small percentage of the keywords are represented in the Bloom filter), make a Bloom filter practical to be used in a smartphone or similar device.

Turning to aspects related to privacy, privacy and contextual advertisements are at odds with each other because the advertisement server 110 needs to know the page content to select a relevant advertisement. The above solution provides some form of privacy in that because only advertisement keywords are supposed to be sent, the advertisement server knows only the advertisement keywords in the page and nothing else. Because advertisement keywords are essentially popular keywords bid on by advertisers, they are likely to be non-sensitive keywords. This also makes it difficult for an adversarial advertiser to exploit the system, because by selecting only popular bidding keywords, an adversary is unlikely to get a sensitive word into the list of popular keywords without making a large number of bids for the same keyword. Note that the advertisement server also may make the list of popular keywords public so that a third party can audit the list to determine whether the list contains any sensitive keywords. However, the technology described herein does not guarantee absolute privacy; in fact, it is basically impossible to guarantee absolute privacy in a client-server contextual advertisement system without sacrificing advertisement quality or system efficiency.

Because a Bloom filter can have false positives, an advertisement client may occasionally send to the advertisement server sensitive words (such as a social security number or a name of a disease) that appear in an application page but are not advertisement keywords. This can violate user's privacy.

To avoid such a potential privacy breach, in one implementation, the advertisement client and the advertisement server each use a one-way hash function and operate on hash values of keywords instead of their plaintexts. The server builds the Bloom filter based upon hash values of the popular advertisement keywords. The client hashes the candidate keywords on the current page and sends only a hash value of a word if the hash value is also represented in the Bloom filter.

The advertisement server 110 maintains a dictionary of the advertisement keywords and their hash values, whereby it can map a hash value back to its plaintext only if it is an advertisement keyword. The server 110 ignores any hash values that do not appear in its dictionary, without knowing (or because of the one-way hash) ever deciphering their plaintexts. In this way, the system achieves privacy in that the advertisement server knows plaintexts of only the words that are popular advertisement keywords.

FIG. 2 shows an example end-to-end workflow/the overall operation of the system. The advertisement server 110 maintains a database 224 containing the advertisement keywords. For each keyword k, the database maintains k, a hash value H(k) of k, and a global feature value Gₖ of K. The value Gₖ is used by the server's keyword extraction algorithm for computing an overall score used in ranking of a keyword. In one implementation of the keyword extractor, Gₖ is computed as log(1+freqₖ), where freqₖ is the number of times K is used to label any advertisement in the advertisement inventory. The database 224 is updated as the advertisement inventory is updated. Periodically (e.g., once every three months) or on some other schedule such as when sufficient changes are detected, in one implementation the server computes a Bloom filter or other similar mechanism/data structure from the H(k) values in the keyword database and sends copies of the computed Bloom filter (e.g., 222) to its clients, e.g., the mobile phone client device 104. The size of the Bloom filter is optimally selected based on the number of keywords in the keyword database and an acceptable target false positive rate.

As described above and shown in detail in FIG. 2, after an application page is loaded, the client component 106 (FIG. 1) “scrapes” the current page content to generate a list of candidate keywords and a local weight for each, {W1, L1 . . . Wn, Ln}. Typical application pages are organized as a hierarchy of UI controls (e.g., text box, images, list box); scraping may be done by traversing the hierarchy and extracting texts in such UI controls. For each scraped word W, the client module computes its hash H(W) (using the same hash function the server uses to generate the keyword database) and its local feature vector Lw, shown as {H(W1), L1 . . . H(Wn), Ln}. If H(W) passes the Bloom filter, the pair (H(W),Lw) is sent to the server, e.g., {H(W1), L1 . . . H(Wk), Lk} (where k is less than or equal to n).

The advertisement server 110 receives this set of hash values and the respective weights for each. If a hash word H(W) value does not appear in the server's keyword database 224 (because the hashed word was sent as a result of a false positive occurring in the client's Bloom filter), the server 110 discards the value, without knowing or being able to determine (because of the one-way hash function) the corresponding word W.

Otherwise, the server retrieves the global weight G_{W} from the keyword database and combines it with L_{W} to compute the overall score of the word W, (e.g., reconverted to plaintext), as represented in FIG. 2 by the score compute component 226. The scores are ranked and/or used in making a selection (block 228). For example, keywords with scores above a threshold may be selected as extracted keywords, for example. These extracted keywords are sent to the advertisement network 112.

One problem with extracting advertisement keywords from application pages is that some pages do not contain enough text and hence keyword extraction does not produce any advertising keywords. To show relevant advertisements for those pages, a multiple-level keywords mechanism may be used. For example, in one implementation, Level 1 keywords are the ones dynamically learned from the current page and Level 2 keywords are the ones dynamically learned from the pages the user has viewed in the current session. Additionally, the advertisement server 110 maintains Level 3 keywords for each application, e.g., learned online from that application's metadata. If the set of Level 1 keywords is empty, Level 2 keywords are used. If both Level 1 and Level 2 keyword sets are empty, Level 3 keywords are used to select relevant advertisements. Preference is thus given to the current page to show advertisements. If the current page does not contain any advertising keywords, the pages the user has visited in the current session are next considered, and if none, application metadata (descriptions and content of the application pages, including ones the user has not visited in this session) are used to extract keywords.

Turning to handling related keywords, as described above, relevance may be improved by the addition of keywords related to the extracted keywords. By way of example, consider that the current application page contains the words “LED TVs are cool” but the set of bidding keywords represented in the Bloom filter contains only one keyword related to the application page, {HDTV}. After filtering based on bidding keywords, the advertisement client will not extract any keywords even though LED TVs and HDTV are related. Typical keyword extraction tools ignore such related words. However, such relations may be captured and used because a typical application page may contain only a small amount of text, whereby capturing related words gives an opportunity to show more relevant advertisements. The set of original bidding keywords may be extended with related words, e.g., {HDTV; LED TV; LCD TV}.

This extended set of bidding keywords and their related words may be referred to as advertisement keywords. Various data sources may be used to find related words, e.g., including a database of related keywords automatically extracted by analyzing search engine web queries and click logs. The degree of relationship between two keywords may be computed based on how often users of the search engine who are searching for those two keywords click on the same URL. Another source may be a web service (such as provided by http://veryrelated.com), which when given a keyword, returns a list of related keywords. The degree of relationship between two keywords may be computed based on how often those two keywords appear in the same webpage and how popular they are on the Internet.

Note that the application developer may supply keywords to an advertisement control or the like at runtime, e.g., an application developer may hard-code static advertisement keywords for every page of an application, or possibly implement some logic to dynamically generate them during runtime. However, such hard-coding and/or logic is hard to implement in practice because for many pages, the developer cannot know what content may be displayed at runtime, and also because the quality of an advertisement keyword depends on external information (e.g., how popular a keyword is among advertisers).

Notwithstanding, certain pages may be static or mostly static, and thus an application developer or other service may request certain advertisements for such a page. For example, before performing extraction, the component 106 described herein may process application metadata and determine that a certain page identifier corresponds to a request for advertisements related to a flower delivery service. For this page, predetermined keywords (or an {ApplicationID, PageID} pair from which the server may look up keywords) may be sent to the server 110 so that relevant advertisements are returned for that particular page.

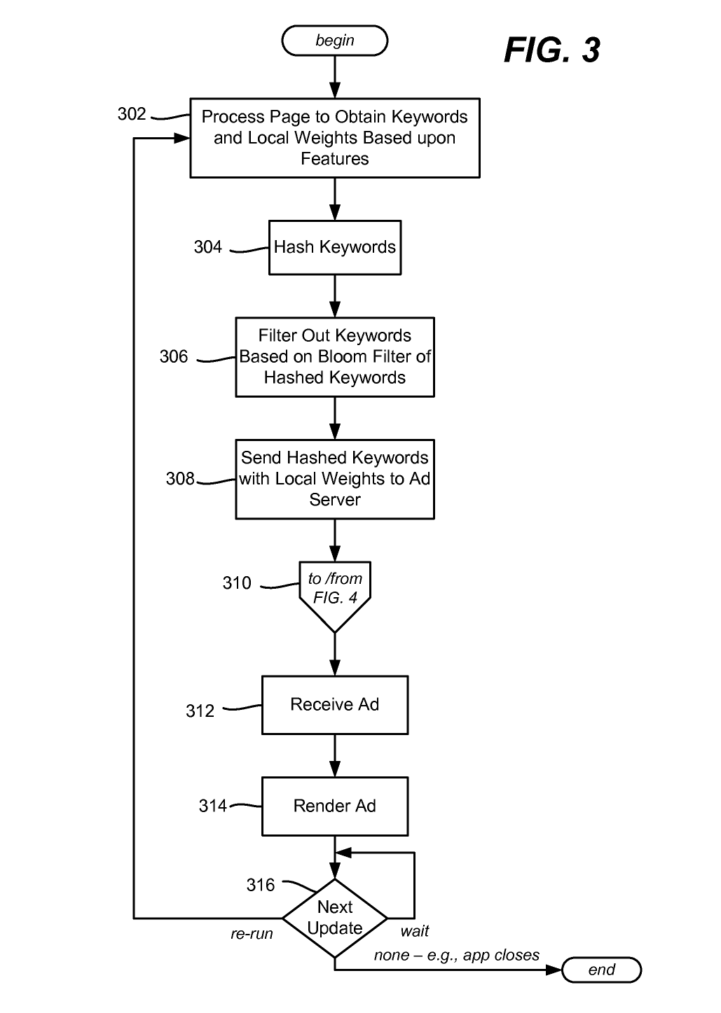

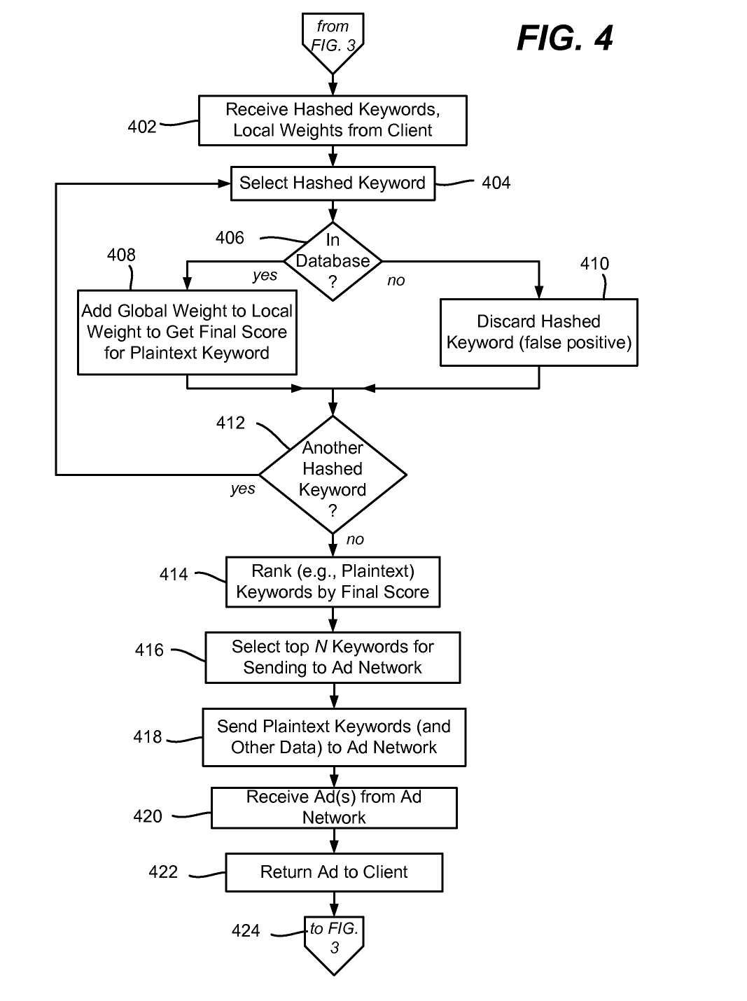

FIG. 3 summarizes some example steps that may be performed by the client-side advertisement component 106, while FIG. 4 summarizes some example steps that may be performed by the advertisement server 110. For purposes of simplicity, the flow diagrams of FIGS. 3 and 4 describe an example in which there is at least one extracted keyword on the page that passes the Bloom filter, and that at least one keyword from the client is in the server database and scored/ranked sufficiently high to be sent to the advertisement network. Situations in which no keywords pass the Bloom filter, and/or in which no extracted keyword can be sent to the advertisement network (any extracted word or words were Bloom filter false positives or scored too low to achieve a threshold) may be handled as described above, e.g., by sending Level 2 or Level 3 words, or via some other scheme.

At step 302 of FIG. 3, the client-side advertisement component 106 processes a current page to obtain the keywords and local weights based upon features, as described herein. Step 304 hashes those keywords for privacy purposes.

Step 306 represents filtering out keywords (their hashed values) via the Bloom filter, so that in general only words that are advertising keywords are sent to the server (although hash values of words corresponding to Bloom filter false positives also may be sent). Step 308 represents sending the set of one or more hashed words and weights for each word. Step 310 transitions to the server steps represented in FIG. 4.

Step 402 of FIG. 4 represents the server receiving the hashed keywords and local weights from the client. For each hashed word (steps 404 and 412), step 406 checks whether the hashed word is in the server database 224. If so, step 408 adds the global weight associated with that hash value to the local weight provided therewith by the client, to provide a final score for the (plaintext) word associated with that hash value. If the hashed value was not in the database, step 410 discards the hashed word.

Step 414 represents ranking the (e.g., after substituting back the plaintext) words by their final score, with step 416 selecting the top N words for sending to the advertisement network. As described above, instead of ranking and selecting via steps 414 and 416, a set of words may be determined by filtering based upon their final scores against a threshold. In any event, in this example at least one word is available for sending to the advertisement network (if no words remain in the set after filtering, another keyword selection scheme or the like may be used as described above, e.g., Level 2 or Level 3 selection). Additional filtering and/or ranking, or augmenting of the keyword set may be done based upon other information, e.g., location, user preferences, user history and so forth.

Step 418 sends the plaintext keyword set to the advertisement network to obtain one or more relevant advertisements in return (step 420). Note that as set forth above, extracted keywords are only one signal that may be used in selection, and thus other data also may be sent (e.g., the client device's current location) for use by the advertisement network. In this way, for example, the advertisement network may know not to return an advertisement for a pizza restaurant in New York when the client device is in the Seattle area. Indeed, the advertisement server and/or the advertisement network can use keywords in conjunction with any other signals such as location, past browsing history, and so forth to select an advertisement.

Step 420 and 422 represent receiving the advertisement or advertisements from the advertisement network 112, which may be a reference to the auxiliary content (e.g., a URL) rather than the content itself. If more than one is returned, the advertisement server 110 selects one. Step 422 returns the advertisement (or a URL thereof) to the client for display; step 424 represents the transition back to step 310 of FIG. 3.

Returning to FIG. 3, step 312 represents receiving the advertisement at the client, which is rendered at step 314, e.g., as a visible (and/or possibly audible) representation of the advertisement. Step 316 represents waiting until the next update, such as if the page changes, or a timer indicates a new advertisement is to be shown. If a timer is reached and the page content has not changed, the extraction at steps 302 to 306 need not be repeated, although some action may be taken at the client to reduce the chances of receiving the identical advertisement, e.g., identify the current advertisement and request that the server return another one.

### Example Operating Environment

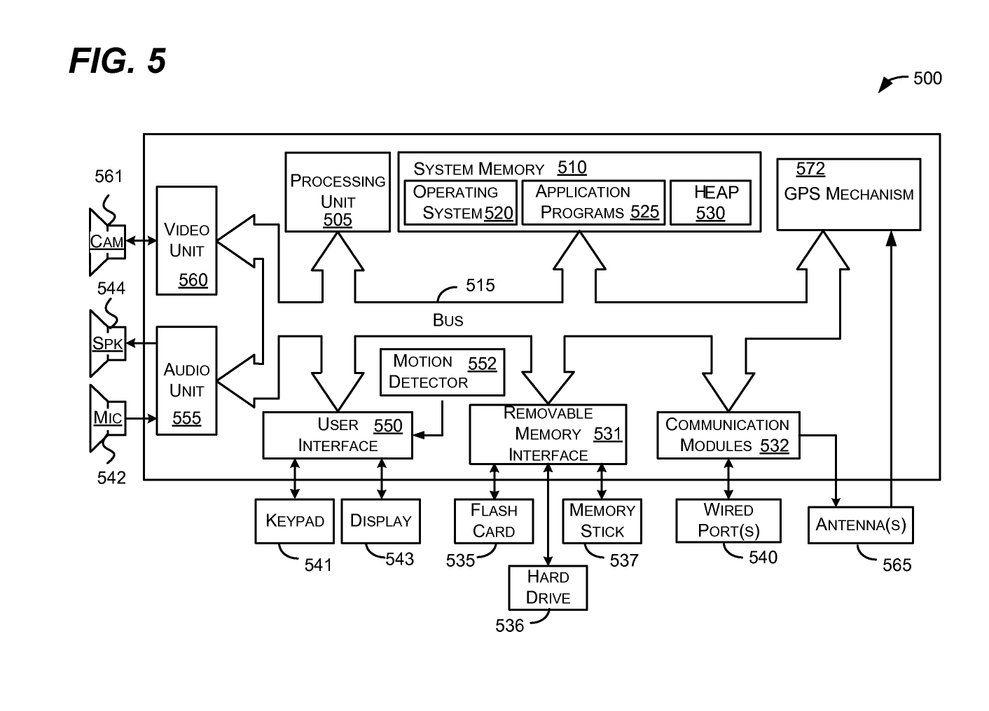

FIG. 5 illustrates an example of a suitable mobile device 500 on which aspects of the subject matter described herein may be implemented. The mobile device 500 is only one example of a device and is not intended to suggest any limitation as to the scope of use or functionality of aspects of the subject matter described herein. Neither should the mobile device 500 be interpreted as having any dependency or requirement relating to any one or combination of components illustrated in the example mobile device 500.

With reference to FIG. 5, an example device for implementing aspects of the subject matter described herein includes a mobile device 500. In some embodiments, the mobile device 500 comprises a cell phone, a handheld device that allows voice communications with others, some other voice communications device, or the like. In these embodiments, the mobile device 500 may be equipped with a camera for taking pictures, although this may not be required in other embodiments. In other embodiments, the mobile device 500 may comprise a personal digital assistant (PDA), hand-held gaming device, notebook computer, printer, appliance including a set-top, media center, or other appliance, other mobile devices, or the like. In yet other embodiments, the mobile device 500 may comprise devices that are generally considered non-mobile such as personal computers, servers, or the like.

The mobile device may comprise a hand-held remote control of an appliance or toy, with additional circuitry to provide the control logic along with a way to input data to the remote control. For example, an input jack or other data receiving sensor may allow the device to be repurposed for non-control code data transmission. This may be accomplished without needing to store much of the data to transmit, e.g., the device may act as a data relay for another device (possibly with some buffering), such as a smartphone.

Components of the mobile device 500 may include, but are not limited to, a processing unit 505, system memory 510, and a bus 515 that couples various system components including the system memory 510 to the processing unit 505. The bus 515 may include any of several types of bus structures including a memory bus, memory controller, a peripheral bus, and a local bus using any of a variety of bus architectures, and the like. The bus 515 allows data to be transmitted between various components of the mobile device 500.

The mobile device 500 may include a variety of computer-readable media. Computer-readable media can be any available media that can be accessed by the mobile device 500 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 500.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 510 includes computer storage media in the form of volatile and/or nonvolatile memory and may include read only memory (ROM) and random access memory (RAM). On a mobile device such as a cell phone, operating system code 520 is sometimes included in ROM although, in other embodiments, this is not required. Similarly, application programs 525 are often placed in RAM although again, in other embodiments, application programs may be placed in ROM or in other computer-readable memory. The heap 530 provides memory for state associated with the operating system 520 and the application programs 525. For example, the operating system 520 and application programs 525 may store variables and data structures in the heap 530 during their operations.

The mobile device 500 may also include other removable/non-removable, volatile/nonvolatile memory. By way of example, FIG. 5 illustrates a flash card 535, a hard disk drive 536, and a memory stick 537. The hard disk drive 536 may be miniaturized to fit in a memory slot, for example. The mobile device 500 may interface with these types of non-volatile removable memory via a removable memory interface 531, or may be connected via a universal serial bus (USB), IEEE 5394, one or more of the wired port(s) 540, or antenna(s) 565. In these embodiments, the removable memory devices 535-437 may interface with the mobile device via the communications module(s) 532. In some embodiments, not all of these types of memory may be included on a single mobile device. In other embodiments, one or more of these and other types of removable memory may be included on a single mobile device.

In some embodiments, the hard disk drive 536 may be connected in such a way as to be more permanently attached to the mobile device 500. For example, the hard disk drive 536 may be connected to an interface such as parallel advanced technology attachment (PATA), serial advanced technology attachment (SATA) or otherwise, which may be connected to the bus 515. In such embodiments, removing the hard drive may involve removing a cover of the mobile device 500 and removing screws or other fasteners that connect the hard drive 536 to support structures within the mobile device 500.

The removable memory devices 535-437 and their associated computer storage media, discussed above and illustrated in FIG. 5, provide storage of computer-readable instructions, program modules, data structures, and other data for the mobile device 500. For example, the removable memory device or devices 535-437 may store images taken by the mobile device 500, voice recordings, contact information, programs, data for the programs and so forth.

A user may enter commands and information into the mobile device 500 through input devices such as a key pad 541 and the microphone 542. In some embodiments, the display 543 may be touch-sensitive screen and may allow a user to enter commands and information thereon. The key pad 541 and display 543 may be connected to the processing unit 505 through a user input interface 550 that is coupled to the bus 515, but may also be connected by other interface and bus structures, such as the communications module(s) 532 and wired port(s) 540. Motion detection 552 can be used to determine gestures made with the device 500.

A user may communicate with other users via speaking into the microphone 542 and via text messages that are entered on the key pad 541 or a touch sensitive display 543, for example. The audio unit 555 may provide electrical signals to drive the speaker 544 as well as receive and digitize audio signals received from the microphone 542.

The mobile device 500 may include a video unit 560 that provides signals to drive a camera 561. The video unit 560 may also receive images obtained by the camera 561 and provide these images to the processing unit 505 and/or memory included on the mobile device 500. The images obtained by the camera 561 may comprise video, one or more images that do not form a video, or some combination thereof.

The communication module(s) 532 may provide signals to and receive signals from one or more antenna(s) 565. One of the antenna(s) 565 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 572. In turn, the GPS mechanism 572 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 500 may connect to one or more remote devices. The remote devices may include a personal computer, a server, a router, a network PC, a cell phone, a media playback device, a peer device or other common network node, and typically includes many or all of the elements described above relative to the mobile device 500.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method comprising, extracting a keyword set comprising one or more keywords from application page content, sending the keyword set to an advertisement server, receiving an advertisement from the advertisement server, and providing the advertisement for rendering in conjunction with the application page content.

2. The method of claim 1 further comprising, computing a local weight based upon features of a keyword, and associating the local weight with the keyword.

3. The method of claim 1 wherein computing the local weight comprises determining at least part of the local weight based on the presence of the keyword within a user interface element of the application page.

4. The method of claim 1 wherein extracting the keyword set comprises determining a set of candidate keywords, and filtering the set of candidate keywords into the keyword set.

5. The method of claim 4 wherein filtering the set of candidate keywords into the keyword set comprises determining whether each candidate keyword is represented in a Bloom filter.

6. The method of claim 1 further comprising hashing plaintext keywords in the application page content into at least some of the keywords of the keyword set.

7. The method of claim 1 further comprising, computing a local weight for a keyword, hashing a plaintext representation of the keyword into a hashed keyword, determining whether the hashed keyword is represented in a Bloom filter, and if so, including the hashed keyword in the keyword set.

8. The method of claim 1 further comprising, receiving an advertisement request including the keyword set at the advertisement server, sending data corresponding to at least one keyword from the keyword set to an advertisement network, receiving the advertisement from the advertisement network, and returning the advertisement in response to the request.

9. The method of claim 8 wherein the keyword set comprises one or more hashed plaintext keywords, and further comprising, determining whether a hashed plaintext keyword is in a database, and if so, retrieving a plaintext keyword and a global weight for the hashed plaintext keyword.

10. The method of claim 9 further comprising, combining the global weight with a local weight received with the hashed plaintext keyword into a score, and wherein sending the data corresponding to at least one keyword from the keyword set to the advertisement network comprises sending the plaintext keyword based at least in part upon the score.

11. A system comprising, an auxiliary content server, the auxiliary content server configured with a memory and processor to execute code, including to:
(a) receive a keyword set from a client, the keyword set including at least one data item having a local weight computed for the data item at the client,
(b) combine a global weight with the local weight for at least one data item of the keyword set into a final score for that item,
(c) retrieve auxiliary content based upon the data item and score, and
(d) return auxiliary content to the client.

12. The system of claim 11 wherein each data item comprises a hashed keyword value of a plaintext keyword.

13. The system of claim 11 wherein the auxiliary content comprises an advertisement, and wherein the auxiliary content server is configured to retrieve the advertisement from an advertisement network.

14. The system of claim 11 wherein each data item comprises a hashed keyword value of a plaintext keyword, wherein the auxiliary content comprises an advertisement, and wherein the auxiliary content server retrieves the global score and the plaintext keyword for a data item based upon the hashed keyword value from a database of advertising keywords.

15. The system of claim 14 wherein the auxiliary content server is further configured to construct a structure comprising compressed data that represents at least some of the advertising keywords in the database, and to provide the structure to the client.

16. The system of claim 14 wherein the auxiliary content server is further configured to construct a Bloom filter that represents at least some of the advertising keywords in the database and words related to at least some of the advertising keywords in the database, and to provide the Bloom filter to the client.

17. One or more computer-readable storage media having executable instructions, which when executed perform steps, comprising,
processing application page content, including extracting a plaintext keyword from the page content;
computing a local weight for the keyword based upon local features;
hashing the plaintext keyword into a hashed keyword;
determining that the hashed keyword is represented in a data structure that maintains compressed data representative of advertising keywords;
sending an advertisement request to an advertisement server, the request including a keyword set including the hashed keyword and the local weight; and
receiving an advertisement from the advertisement server in response to the request.

18. The one or more computer-readable storage media of claim 17 having further computer-executable instructions comprising, receiving the data structure in the form of a Bloom filter from a remote server comprising the advertisement server or another server coupled thereto.

19. The one or more computer-readable storage media of claim 17 having further computer-executable instructions comprising, at the advertisement server, receiving the advertisement request, accessing a database to obtain a global weight maintained for the hashed keyword, combining the global weight with the local weight into a score, and based upon the score, sending a plaintext keyword corresponding to the hashed keyword to an advertisement network to obtain the advertisement.

20. The one or more computer-readable storage media of claim 17 having further computer-executable instructions comprising using the score to rank the hashed keyword or plaintext keyword corresponding thereto against another score of another hashed keyword or plaintext keyword corresponding thereto, or selecting the plaintext keyword for sending based at least in part on the score, or both.
